(19) United States
(12) Patent Application Publication
(10) Pub. No.: US 2014/0194154 A1
(43) Pub. Date: Jul. 10, 2014

(54) RTT Quality Improvement By Compensation Of Artifacts Introduced By AP And STA

(71) Applicant: QUALCOMM INCORPORATED, San Diego, CA (US)

(72) Inventors: Vinay SRIDHARA, Santa Clara, CA (US); Sina FIROUZABADI, Sunnyvale, CA (US); Ayman Fawzy NAGUIB, Cupertino, CA (US)

(73) Assignee: QUALCOMM INCORPORATED, San Diego, CA (US)

(21) Appl. No.: 13/737,885

(22) Filed: Jan. 9, 2013

(51) Int. Cl. H04W 24/02

(52) U.S. Cl. CPC H04W 24/02
USPC 455/500; 455/63.1; 455/39

(57) ABSTRACT

A system and method is described herein for compensating for artifacts introduced by nodes in a wireless network. The method may include transmitting, by a first node, first characteristic information indicating the frequency response of the first node to a mobile station in the wireless network and receiving, by the first node from the mobile station, second characteristic information indicating the frequency response of a second node in the wireless network. By broadcasting the frequency response of each node in the network to each other node, the method may produce a compensated channel estimation that eliminates or reduces artifacts introduced by the nodes to wireless signals.

### FIELD

The subject matter disclosed herein relates generally to a method for determining a wireless channel's actual frequency response by compensating for artifacts introduced by wireless nodes. Specifically, each node in a network advertises its own frequency response and receives the frequency response of all other nodes in the network, such that a channel estimation may be computed that compensates for artifacts introduced by each node.

### BACKGROUND

Wireless devices/nodes communicate in a wireless system/network over wireless channels using one or more protocols. Communications may include the transmission and/or reception of audio, video, voice, and/or signaling data. Each wireless node may include a number of active and passive components in the receiving and transmission path for these communications. For example, the signal chain in a wireless node may include one or more analog and digital filters. Generally, these components improve the transmission or the reception quality of associated wireless signals. For example, digital and analog filters in a wireless node may improve the bandwidth and transmission capabilities for a set of signals.

Although the presence of these active and passive components may improve certain aspects of signal transmission and reception, these components may also introduce artifacts that alter the way the wireless channel is estimated. For example, a notch filter in the signal chain of a wireless node may introduce peaks that distort channel estimation. Poor channel estimation may affect the way positioning of the wireless node (while enhancing (or not affecting) the data reception capability) is determined using a calculated round-trip time (RTT) or received signal strength indicator (RSSI), which depend on accurate channel estimation. Additionally, introduction of artifacts into a signal may falsely indicate the use of cyclic shift diversity (CSD) in a wireless signal.

### SUMMARY

An embodiment of the invention is directed to a method for compensating for artifacts introduced by nodes in a wireless network. The method may include transmitting, by a first node, first characteristic information indicating the frequency response of the first node to a mobile station in the wireless network and receiving, by the first node from the mobile station, second characteristic information indicating the frequency response of a second node in the wireless network. By broadcasting the frequency response of each node in the network to each other node, the method may produce a compensated channel estimation that eliminates or reduces artifacts introduced by the nodes to wireless signals.

Another embodiment of the invention is directed to a method to compensate for artifacts in a wireless network, comprising: transmitting, by a first node, first characteristic information indicating the frequency response of the first node to a mobile station in the wireless network; and receiving, by the first node from the mobile station, second characteristic information indicating the frequency response of a second node in the wireless network.

Another embodiment of the invention is directed to a non-transient machine-readable medium comprising instructions, which, when executed by a machine, cause the machine to perform operations, the instructions comprising: transmit, by a first node, the frequency response of the first node to each node in the wireless network; and receive, by the first node, the frequency response of each node in the wireless network.

Another embodiment of the invention is directed to a mobile station, comprising: a transceiver for receiving characteristic information from a new node joining a network, wherein the characteristic information indicates the frequency response of the new node, and transmitting the frequency response to each node in the network; and a data store for storing the received frequency response.

Another embodiment of the invention is directed to a system for performing data communications, comprising: a first node in a network for transmitting first characteristic information indicating the frequency response of the first node; and a mobile station for receiving the first characteristic information and broadcasting the frequency response of a second node in the network to the first node.

Another embodiment of the invention is directed to a mobile node, comprising: one or more filters for processing wireless signals; and a transceiver for (1) transmitting first characteristic information indicating the frequency response of the one more filters to a mobile station in a network and (2) receiving second characteristic information indicating the frequency response of a remote device in the network.

Another embodiment of the invention is directed to a mobile station, comprising: a means for receiving characteristic information from a new node joining a network, wherein the characteristic information indicates the frequency response of the new node, and transmitting the frequency response to each node in the network; and a means for storing the received frequency response.

The above summary does not include an exhaustive list of all aspects of the present invention. It is contemplated that the invention includes all systems and methods that can be practiced from all suitable combinations of the various aspects summarized above, as well as those disclosed in the Detailed Description below and particularly pointed out in the claims filed with the application. Such combinations have particular advantages not specifically recited in the above summary.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout and wherein:

FIG. 1 shows a wireless network with a wireless station node and one or more mobile nodes according to one embodiment;

FIG. 2 shows a schematic representation of a wireless system between a wireless initiator and a wireless responder that communicate over a wireless channel according to one embodiment;

FIG. 3 shows an example preamble for a packet transmitted between the initiator and the responder according to one embodiment;

FIG. 4 shows a method for calculating an actual/compensated channel estimation according to one embodiment;

FIG. 5 shows a component diagram of a mobile station for storing the characteristic information of each node in the network according to one embodiment;

FIG. 6 demonstrates an example situation using the method of FIG. 4;

FIG. 7 shows the power distribution for a wireless signal before compensation; and

FIG. 8 shows the power distribution for the wireless signal of FIG. 7 after compensation.

### DESCRIPTION

This invention is not limited in its application to the details of construction and the arrangement of components set forth in the following description or illustrated in the drawings. The invention is capable of other embodiments and of being practiced or of being carried out in various ways. Also, the phraseology and terminology used herein is for the purpose of description and should not be regarded as limiting. The use of “including,” “comprising,” or “having,” “containing”, “involving”, and variations thereof herein, is meant to encompass the items listed thereafter and equivalents thereof as well as additional items. The word “exemplary” is used herein to mean “serving as an example, instance, or illustration.” Any embodiment or design described herein as “exemplary” is not necessarily to be construed as preferred or advantageous over other embodiments or designs

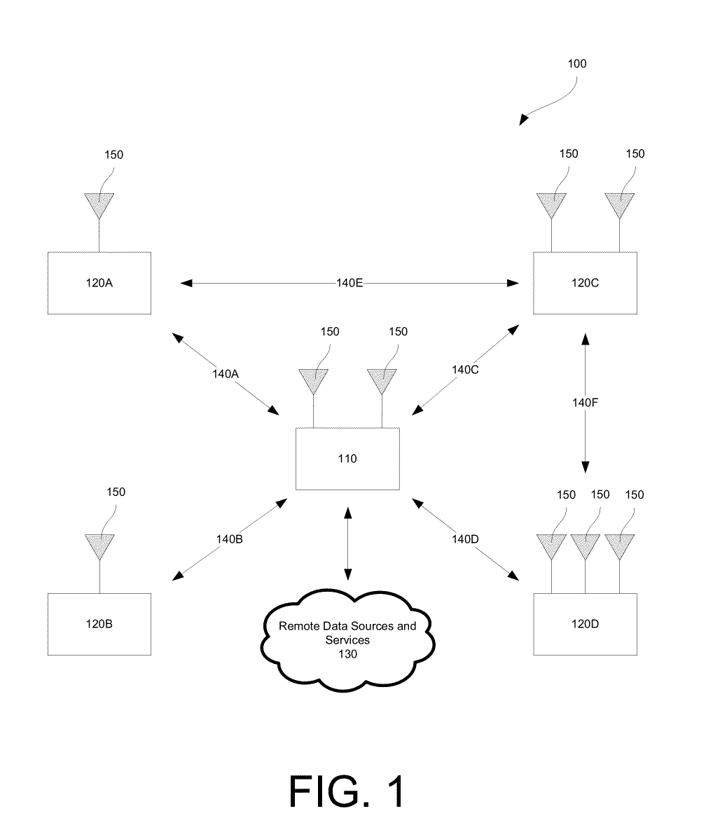

FIG. 1 shows a wireless network 100 with a wireless station node 110 and one or more mobile nodes 120 according to one embodiment. The wireless station node 110 is a device that may simultaneously communicate with multiple mobile nodes 120 and other devices using both wired and wireless protocols and mediums. For example, the wireless station node 110 may be one or more of a router, a hub, a base station, a base transceiver subsystem (BTS), or another similar device that is capable of providing the mobile nodes 120 access to one or more remote data sources or services 130. Although shown as including a single wireless station node 110, the wireless network 100 may include multiple wireless station nodes 110 that communicate with each other and the mobile nodes 120 over wireless channels 140. The wireless network 100 may be a wireless cellular network (e.g., a code division multiple access (CDMA) network, a time division multiple access (TDMA) network, a 3GPP Long Term Evolution (LTE) network, etc.), a wireless local data network (e.g., an IEEE 802.11x network), or any other network (e.g., a Transmission Control Protocol and Internet Protocol (TCP/IP) network).

The mobile nodes 120 may be a computing device that can communicate with the mobile nodes 120 and wireless station node 110 via one or more wireless protocols and mediums. A mobile node 120 may alternately be referred to as a terminal, an access terminal, a user terminal, a mobile station, a mobile device, a remote station, a user device, a user agent, a subscriber station, a subscriber unit, or other similar devices. In an one embodiment, the mobile nodes 120 are one or more of a cellular phone, a cordless phone, a Session Initiation Protocol (SIP) phone, a wireless local loop (WLL) station, a handheld device, a wireless device, a personal digital assistant (PDA), a laptop computer, a computing device, a wireless modem card, a media device (e.g., a television, a DVD player, a wireless speaker, a camera, a camcorder, a webcam, etc.), or other similar devices. The mobile nodes 120 may communicate with each other indirectly through the wireless station node 110 over the wireless channels 140A, 140B, 140C, and 140D. Alternatively, the mobile nodes 120 may also directly communicate peer-to-peer with another mobile node 120 without assistance from the wireless station node 110. For example, the mobile node 120A may communicate with the mobile node 120C via wireless channel 140E and the mobile node 120C may communicate with the mobile node 120D over wireless channel 140F. The wireless channels 140 may be implemented using any known set of wireless protocols, including CDMA, TDMA, 3GPP LTE, TCP/IP, and IEEE 802.11x.

The nodes 110 and 120 may communicate various types of data over the wireless channels 140. For example, the nodes 110 and 120 may communicate audio, video, voice, or signaling data over the wireless channels 140 using any known protocols and/or encoding techniques. For example, the mobile nodes 120 may transmit and/or receive RTS/CTS packets for obtaining a round-trip time (RTT) or a received signal strength indicator (RSSI).

The wireless station node 110 and the mobile nodes 120 may be equipped with a single antenna 150 or multiple antennas 150 for data transmission and reception over the wireless channels 140. In the embodiment illustrated in FIG. 1, the wireless station node 110 is equipped with two antennas 150, the mobile nodes 120A and 120B are each equipped with a single antenna 150, the mobile node 120C is equipped with two antennas 150, and the mobile node 120D is equipped with three antennas 150. The antennas 150 may be of any type for use with any known protocol or standard. For example, the antennas 150 may be capable of communicating using GSM/GPRS and UMTS/HSDPA/WCDMA protocols.

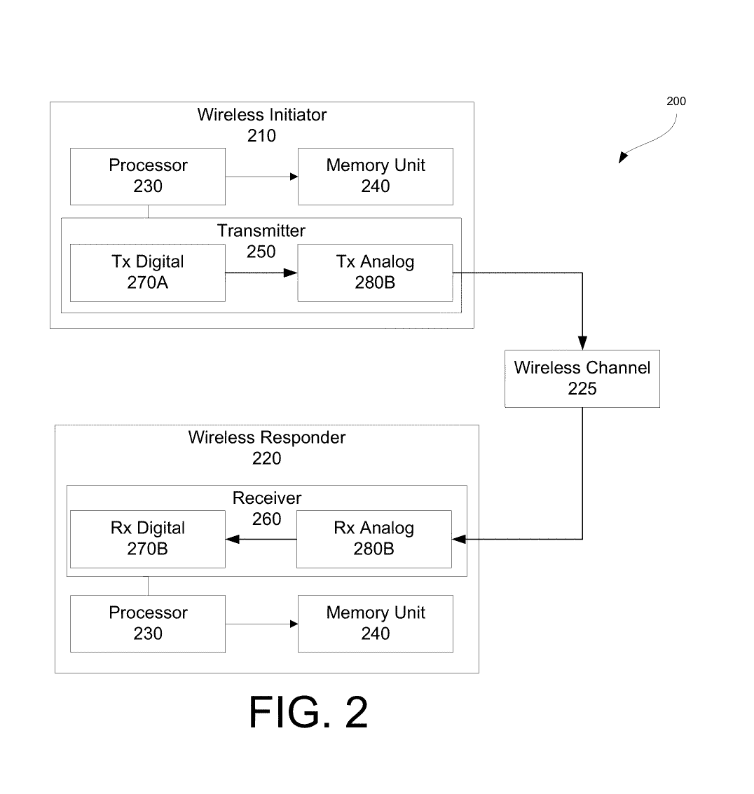

FIG. 2 shows a schematic representation of a wireless system 200 between a wireless initiator 210 and a wireless responder 220 that communicate over a wireless channel 225. The initiator 210 and responder 220 may be one or more of the wireless station node 110 and the mobile nodes 120 shown in FIG. 1. For example, the wireless initiator 210 may be the mobile node 120A while the wireless responder 220 may be the wireless station node 110.

The wireless initiator 210 and the wireless responder 220 each respectively include a processor 230 and a memory unit 240 for generating and processing wireless data communication signals. The processors 230 and memory units 240 are generically used here to refer to any suitable combination of programmable data processing components and data storage that conduct the operations needed to implement the various functions and operations of the initiator 210 and responder 220. The processors 230 may be an applications processor typically found in a smart phone, while the memory unit 240 may refer to microelectronic, non-volatile random access memory. An operating system may be stored in the memory unit 240, along with application programs specific to the various functions of the initiator 210 and responder 220, which are to be run or executed by the processors 230 to perform the various functions of the initiator 210 and the responder 220.

The initiator 210 and responder 220 may each include a series of components that process transmitted and received wireless data signals. For example, the wireless initiator 210 includes a transmitter 250 comprised of a set of digital filters 260A and analog filters 270A that process signals produced by the processor 230 before being transmitted over the wireless channel 225 to the wireless responder 220. Similarly, the wireless responder 220 includes a receiver 260 comprised of a set of digital filters 260B and analog filters 270B that process signals received from the wireless initiator 210 before the received signals are fed to the receiver's processor 230. The digital and analog filters 270 and 280 may be used to improve the transmission and/or the reception quality of wireless signals over the wireless channel 225. For example, the filters 270A and 280A may boost transmitted signal strength over a designated set of frequencies.

During the transmission of data in the wireless system 200, knowledge of the properties and characteristics of the wireless channel 225 between the initiator 210 and the responder 220 is useful to improve data transmission performance Channel estimation is performed to capture many of these characteristics of the wireless channel 225, including the frequency response of the wireless channel 225. The frequency response defines how data signals propagate through the wireless channel 225, including delays and alterations to the signals caused by the wireless channel 225.

Channel estimation must be accurately performed such that data packets are correctly decoded and demodulated after transmission to compensate for effects caused by channel distortion. For example, an email data packet may be warped during transmission such that the decoded email text is inaccurate or unreadable. However, if the channel estimation is inaccurate, the data packets may remain distorted or unreadable. Similarly, position determinations using RTT and RSSI calculations may be imprecise using inaccurate channel estimations.

Although channel estimation seeks to determine the frequency response of just the wireless channel 225, the estimate may also unintentionally include artifacts introduced by components in the signal chain of the initiator 210 and the responder 220. For example, channel estimation test signals/symbols may be included in the preamble of one or more packets transmitted between the initiator 210 and the responder 220. The initiator 210 and/or the responder 220 analyze the received symbols and produce a channel estimation for the wireless channel 225 based on detected differences in transmitted and received symbols. The channel estimation is used to rectify transmitted data with the data actually received.

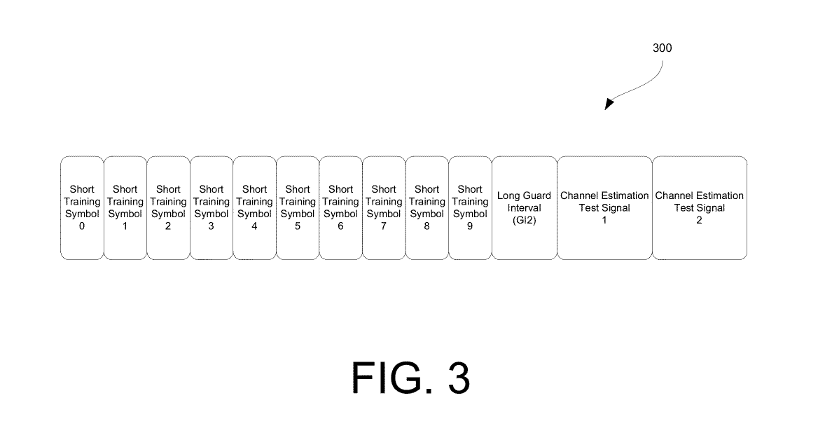

FIG. 3 shows an example preamble 300 for a packet transmitted between the initiator 210 and the responder 220. The packets may be used in any wireless system, including an IEEE 802.11a/g orthogonal frequency-division multiplexing (OFDM) network. The preamble 300 may include one or more short training symbols. For example, the preamble 300 includes ten short training symbols, but in other embodiments different amounts of short training symbols may be used. The short training symbols may be used for signal detection, automatic gain control, diversity selection, coarse acquisition, and frequency synchronization. In order to ensure timely gain control for transmitted and received signals and provide reliable transmission with stable gain, short training symbols may be used to adjust the strength of transmitted and received signals to an optimum level with the dynamic range of various signal processing components in the signal path.

The preamble 300 may additionally include long training symbols as shown in FIG. 3. The long training symbols may be used for channel estimation and/or fine frequency offset correction. The long training symbols may be paired with a short guard interval (GI) or a long guard interval (GI2) that consist of 32 or 64 data samples for OFDM and MIMO long training symbols, respectively.

The long training symbols may be transmitted from the initiator 210 to the 220 in the preamble of one or more data packets. For example, the preamble of a request-to-send (RTS) packet or a clear-to-send (CTS) packet may include one or more long training symbols for use with channel estimation. The long training symbols are globally known between the initiator 210 and the responder 220 such that alterations in long training symbols during the transmission may be determined and compensated for through channel estimation.

Since the test symbols pass through components of the initiator 210 and the responder 220, the channel estimation includes artifacts introduced by these devices and is not solely an estimate of the wireless channel 225. For example, the analog and digital filters 270 and 280 in the initiator 210 and the responder 220 may alter the test symbols before or after they travel over the wireless channel 225. The channel estimation may be represented as:

H_{EST}=H_{Tx}×H_{CH}×H_{Rx} (Equation 1)

As shown the channel estimation H_{EST} for the wireless system 200 includes the actual transfer function H_{CH} for the wireless channel 225 as well as the transfer functions H_{Tx} and H_{Rx} for both the initiator 210 and the responder 220, respectively. Accordingly, the channel estimation H_{EST} does not accurately represent the wireless channel 225 as it introduces artifacts from the wireless initiator 210 and the wireless responder 220. To arrive at the transfer function H_{CH} for the wireless channel 225 using traditional channel estimation techniques, the transfer functions H_{Tx} and H_{Rx} (i.e., the frequency responses for the wireless initiator 210 and the wireless responder 220) must be determined and compensated for or removed during channel estimation calculations.

The frequency response for the wireless initiator 210 and the wireless responder 220 may be represented in terms of the individual frequency responses for filters or other components in the signal chain for the initiator 210 and the responder 220, respectively. For example, the frequency response for the wireless initiator 210 comprising N digital and/or analog filters 270A and 280A may be represented as:

H_{Tx}=H_{Tx}_{_{—}}_{Filter1}× . . . ×H_{Tx}_{_{—}}_{FilterN} (Equation 2)

As shown, the frequency response of the wireless initiator 210 is represented by the transfer function for each of the filters 270A and 280A in the transmitter 250 signal chain. Similarly, the frequency response for the wireless responder 220 comprising N digital and/or analog filters 270B and 280B may be represented as:

H_{Rx}=H_{Rx}_{_{—}}_{Filter1}× . . . ×H_{Rx}_{_{—}}_{FilterN} (Equation 3)

As noted above, the filters 270 and 280 in the initiator 210 and the responder 220 may be digital or analog filters that process and improve the transmission/reception quality of corresponding signals. Although described in terms of the filters 270 and 280, the frequency responses H_{Tx} and H_{Rx} of the wireless initiator 210 and the wireless responder 220 may also include other components in the signal chain. The use of filters 270 and 280 is used for simplicity and in other embodiments the frequency responses H_{Tx} and H_{Rx} may include other components in the initiator 210 and the responder 220, respectively, which effect or alter wireless signals. Based on the frequency response H_{Tx} for the wireless initiator 210 and the frequency response H_{Rx} for the wireless responder 220, the wireless channel's actual frequency response H_{CH} may be represented as:

$${H}_{CH} = \frac{{H}_{EST}}{\begin{matrix}( {H}_{Tx\_Filter 1} \times … \times {H}_{Tx\_FilterN} ) \times \\ ( {H}_{Rx\_Filter 1} \times … \times {H}_{Rx\_FilterN} )\end{matrix}} \qquad ( Equation 4 )$$

Since the actual/compensated frequency response H_{CH} of the wireless channel 225 is typically calculated by an individual node (i.e., either the wireless initiator 210 or the wireless responder 220), the frequency response of only one set of filters 270 and 280 may be known during channel estimation calculation. For example, the wireless responder 220 may seek to perform channel estimation in response to receiving a data packet from the wireless initiator 210. Although the wireless responder 220 may know the frequency responses for its own filters 270B and 280B, the wireless responder 220 may be unaware of the frequency responses of the filters 270A and 280A. Thus, artifacts created by the wireless initiator 210 cannot be compensated for by the wireless responder 220, because the wireless responder 220 has no information on the frequency response for the filters 270A and 280A. To correct for this lack of information, the filters 270 and 280 for initiator 210 and the responder 220 may be made available to the all the nodes upon joining the network.

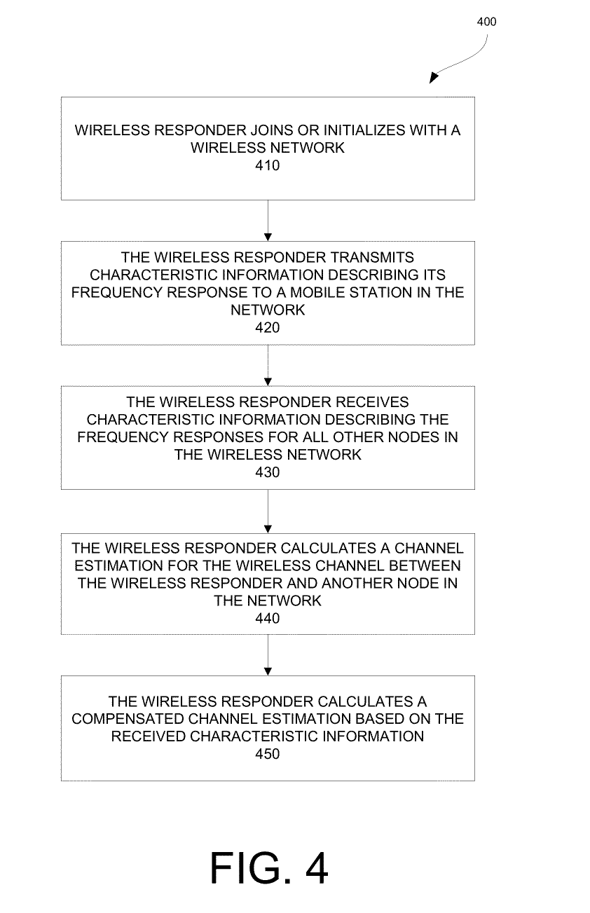

FIG. 4 shows a method 400 for calculating an actual/compensated channel estimation according to one embodiment. The method begins at operation 410 with the wireless responder 220 joining or initializing with a wireless network. The network may be similar to the network 100 shown in FIG. 1. The wireless responder 220 may join the network using any known protocol or technique. For example, the responder 220 may have joined the network upon receiving an Internet Protocol address from a router or other network infrastructure component in the network. The network may include one or more additional connected nodes, including the wireless initiator 210.

After joining or initializing with the network, the responder 220 transmits characteristic information describing its frequency response to a mobile station in the network at operation 420. The frequency response may be described in terms of one or more transfer functions corresponding to the filters 270B and 270B. The transfer function is a mathematical representation, in terms of spatial or temporal frequency, of the relation between the input and output of wireless signals for the responder 220.

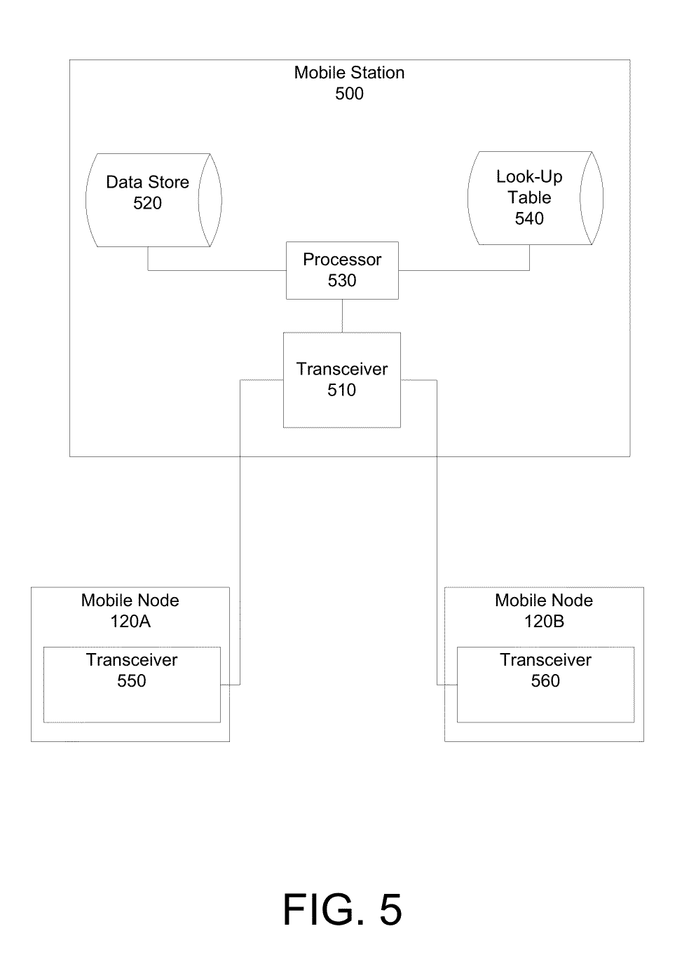

As noted above, the transmission of the characteristic information at operation 420 may be to a dedicated mobile station after initialization with the wireless network. In one embodiment, the mobile station may be another node in the network (e.g., a wireless station node 110 or a router). FIG. 5 shows a component diagram of a mobile station 500 for storing the characteristic information of each node in the network according to one embodiment. The mobile station 500 may include a transceiver 510 for receiving the characteristic information from each node and a data store 520 for storing the characteristic information for each node in the network. The transceiver 510 may be any network communications component capable of receiving and transmitting data through a network. For example, the transceiver 510 may receive characteristics information from mobile nodes 120A and 120B through transceivers 550 and 560, respectively. The transceiver 510 may be a wired or wireless network interface controller (NIC), a wired or wireless host bus adapter (HBA), or any other type of wired or wireless interface adapter. The data store 520 may be any storage medium, including volatile and non-volatile memory units for storing the characteristic information. In one embodiment, the mobile station 500 includes a processor 530 for managing data and processing requests from other nodes in the network. For example, the processor 530 may signal the transceiver 510 to transmit characteristic information to mobile nodes 120A and 120B via transceivers 550 and 560, respectively.

In another embodiment, the characteristic information is distributed throughout the network instead of centralized with the mobile station 500. In this embodiment, the wireless responder 220 transmits its own characteristic information to each other node in the wireless network at operation 420.

The characteristic information transmitted at operation 420 may include the actual frequency response for the responder 220 represented as one or more transfer functions. In another embodiment, the characteristic information may include a set of parameters indicating a type of node (e.g., the vendor and model number of the responder 220). For example, the characteristic information may indicate that the responder 220 is a wireless phone designed or manufactured by Company ABC, with model number 12345. Based on this information indicating the node type, the frequency response for the responder 220 may be retrieved by the mobile station 500. As shown in FIG. 5, the mobile station 500 may include a lookup table 540 for storing and retrieving the frequency response based on the specified node type. In other embodiments, the mobile station 500 may use other databases (e.g., relational and object oriented databases) and/or data structures for storing and retrieving the frequency response based on the specified node type. In one embodiment, the mobile station 500 may retrieve the frequency response for the specified node type by accessing a remote server using the integrated transceiver 510.

After uploading characteristic information describing its own frequency response, the responder 220 receives characteristic information describing the frequency responses for all other nodes in the wireless network at operation 430. As noted above, the frequency responses describe the manner in which a signal is processed or altered by a corresponding node. In one embodiment, the characteristic information from all other nodes in the network is received from the mobile station 500. For example, the mobile station 500 may compile the characteristic information from all other nodes in the network stored in the data store 520 and transmit this information to the responder 220. The characteristic information may be included in assistance data transmitted to the responder 220 upon initialization with the wireless network. Accordingly, the responder 220 is aware of the frequency responses of every other node upon joining the network.

The mobile station 500 may store the assistance data in the data store 520 to form an assistance data database. The mobile station 500 may periodically transmit or otherwise communicate this assistance data to access points in the network to improve mobile based positioning. In one embodiment, the assistance data includes various pieces of information apart from characteristic information of nodes in the network. For example, the assistance data may include information regarding the type, location, and frequency response of one or more access points in the network.

In one embodiment, operation 430 is performed for each node in the wireless network upon a new node entering/joining the network. For example, each node in the wireless network receives updated assistance data that includes the frequency response of every other node in the network when a new node joins the network. In another embodiment, the characteristic information is periodically transmitted to each node in the network at discrete time intervals. By retransmitting the frequency responses of each node in the network, each node is constantly updated with the current frequency responses of every other node in the wireless network.

As noted above, in another embodiment the characteristic information is distributed throughout the network instead of centralized with the mobile station 500. In this embodiment, each node transmits its own characteristic information to the responder 220 at operation 430.

Based on the characteristic information received from each node in the wireless network, the responder 220 may perform channel estimation at operation 440. The channel estimation may be made in response to a data packet transmission/reception from/to another node in the wireless network. For example, upon receiving a data packet from the initiator 210, the responder 220 may retrieve one or more long training symbols from the preamble of the data packet. These long training symbols are analyzed to estimate the frequency response of the wireless channel 225.

As described above and shown in Equation 1, this channel estimation calculated at operation 430 may be inherently inaccurate as it introduces artifacts from the initiator 210 and the responder 220. At operation, 450 a compensated channel estimation H_{CH} is calculated based on the frequency responses of the initiator 210 and the responder 220. For example, the responder 220 may retrieve the Media Access Control (MAC) address or other data identifying the initiator 210 in the received data packet. The MAC address may be used to lookup a corresponding frequency response for the initiator 210. This determined frequency response in conjunction with the already known frequency response of the responder 220 may be used to calculate the wireless channel's actual/compensated frequency response H_{CH} using Equation 4. By knowing the wireless channel's actual frequency response, data packets may be adjusted to eliminate or reduce distortions introduced by the wireless channel 225. For example, the positioning of the wireless responder 220 using RTT and RSSI and detection of cyclic shift diversity (CSD) may be more accurately determined by eliminating artifacts in a transmission.

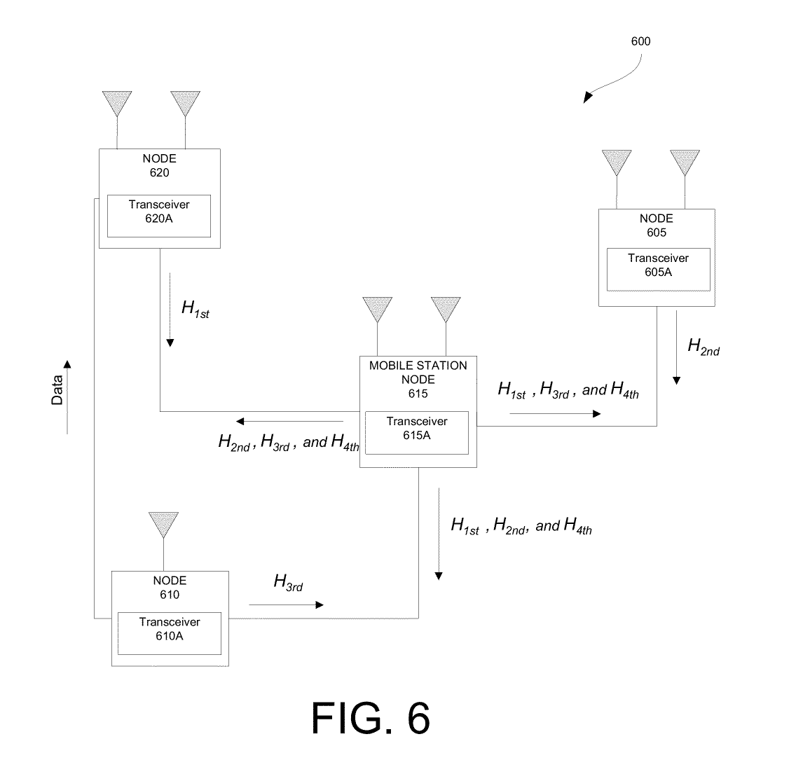

FIG. 6 demonstrates an example situation using the method 400 of FIG. 4. In this example, a wireless network 600 includes nodes 605, 610, and 615 as shown in FIG. 6. The node 615 may act as a mobile station 500 to coordinate and distribute characteristic information regarding each node in the wireless network 600.

In the example situation shown in FIG. 6, the node 620 has just entered the wireless network 600. For example, the node 620 may exchange a series of packets with network infrastructure components to obtain an IP address, such that the node 620 may operate within the wireless network 600.

Upon connecting to or initializing with the wireless network 600, the node 620 uploads characteristic information to the node 615 using transceivers 615A and 620A, respectively, as described in operation 420. The characteristic information may comprise a transfer function H₁ₛₜ, which is a mathematical representation, in terms of spatial or temporal frequency, of the relation between the input and output of wireless signals for the node 620. Although described as a transfer function, the characteristic information may alternately be data indicating a node type (e.g., a manufacturer and model number). Based on the received node type data, the node 615 may determine the transfer function corresponding to node 620 using a look-up table or other mechanism.

After uploading its own characteristic information (e.g., a transfer function representing the frequency response of the node 620), the node 620 receives assistance data from the node 615 as described in operation 430. The assistance data may include the transfer functions H_{2nd}, H_{3rd}, and H₄ₜₕ corresponding to the nodes 605, 610, and 615 received through transceivers 605A, 610A, and 615A, respectively. By receiving each of the transfer functions for each of the other nodes in the wireless network 600, the node 620 may compensate for artifacts introduced by each of the nodes 605, 610, and 615 during channel estimation calculations.

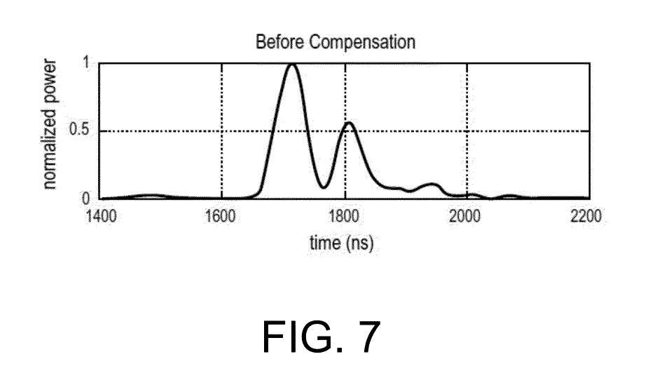

Following receipt of the assistance data, which includes data indicating the frequency responses of nodes 605, 610, and 615 (e.g., transfer functions H_{2nd}, H_{3rd}, and H₄ₜₕ), the node 620 may initiate the calculation of an actual/compensated channel estimation H_{CH}. For example, the node 620 may receive a data packet from node 610. The received data packet is represented by the signal shown in FIG. 7. As shown, the signal includes multiple peaks. Multiple peaks may be associated with a CSD signal (i.e., multipath set of signals for non-line of sight communications). However, the multiple peaks may also be introduced by filters or other components in the nodes 610 and 620. To determine whether the received signal is using CSD, the node must compensate for artifacts introduced by the nodes 610 and 620.

To compensate for the effects of the nodes 610 and 620 to the received signal, a compensated channel estimation H_{CH} is obtained by eliminating artifacts introduced by the nodes 610 and 620. For example, the node 620 may use its own frequency response H₁ₛₜ and the frequency response H_{3rd} corresponding to the node 610 to generate a compensated channel estimation H_{CH} using the equation below:

$${H}_{CH} = \frac{{H}_{EST}}{{H}_{1 st} \times {H}_{3 rd}} \qquad Equation 5$$

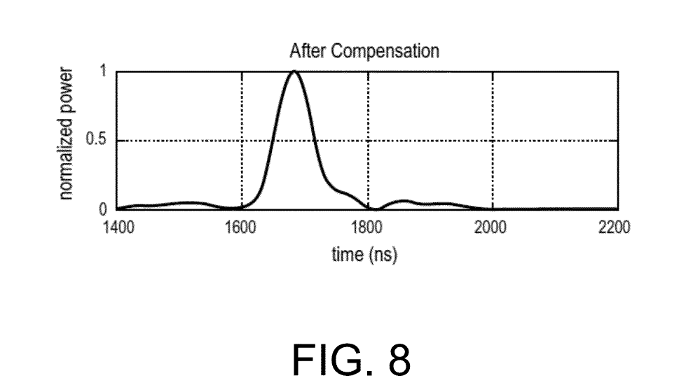

As shown in FIG. 8, the signal generated using this compensated frequency response H_{CH} eliminates artifacts introduced by the nodes 610 and 620. Using this artifact free signal, the node 610 may properly determine that CSD is not being utilized as there are not multiple peaks corresponding to a multipath system.

Although described in relation to CSD detection, the example provided above in relation to FIGS. 6-8 may be similarly applied for the accurate calculation of RTT or RSSI for mobile and network based positioning systems. Processing wireless signal in the above manner increases accuracy of positioning estimation and general data communications.

As used herein, a mobile station (MS) or node refers to a device such as a cellular or other wireless communication device, personal communication system (PCS) device, personal navigation device (PND), Personal Information Manager (PIM), Personal Digital Assistant (PDA), laptop, tablet or other suitable mobile device which is capable of receiving wireless communication and/or navigation signals. The term “mobile station” is also intended to include devices which communicate with a personal navigation device (PND), such as by short-range wireless, infrared, wireline connection, or other connection—regardless of whether satellite signal reception, assistance data reception, and/or position-related processing occurs at the device or at the PND. Also, “mobile station” is intended to include all devices, including wireless communication devices, computers, laptops, etc. which are capable of communication with a server, such as via the Internet, Wi-Fi, or other network, and regardless of whether satellite signal reception, assistance data reception, and/or position-related processing occurs at the device, at a server, or at another device associated with the network. Any operable combination of the above are also considered a “mobile station.”

The methodologies described herein may be implemented by various means depending upon the application. For example, these methodologies may be implemented in hardware, firmware, software, or any combination thereof. For an implementation involving hardware, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

For an implementation involving firmware and/or software, the methodologies may be implemented with modules (e.g., procedures, functions, and so on) that perform the functions described herein. Any machine-readable medium tangibly embodying instructions may be used in implementing the methodologies described herein. For example, software codes may be stored in a memory and executed by a processing unit. Memory may be implemented within the processing unit or external to the processing unit. As used herein the term “memory” refers to any type of long term, short term, volatile, nonvolatile, or other memory and is not to be limited to any particular type of memory or number of memories, or type of media upon which memory is stored.

If implemented in firmware and/or software, the functions may be stored as one or more instructions or code on a computer-readable medium. Examples include computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage, semiconductor storage, or other storage devices, or any other medium that can be used to store desired program code in the form of instructions or data structures and that can be accessed by a computer; disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

In addition to storage on computer-readable medium, instructions and/or data may be provided as signals on transmission media included in a communication apparatus. For example, a communication apparatus may include a transceiver having signals indicative of instructions and data. The instructions and data are configured to cause one or more processing units to implement the functions outlined in the claims. That is, the communication apparatus includes transmission media with signals indicative of information to perform disclosed functions. At a first time, the transmission media included in the communication apparatus may include a first portion of the information to perform the disclosed functions, while at a second time the transmission media included in the communication apparatus may include a second portion of the information to perform the disclosed functions.

What is claimed is:

1. A method to compensate for artifacts in a wireless network, comprising:
transmitting, by a first node, first characteristic information indicating the frequency response of the first node to a mobile station in the wireless network; and
receiving, by the first node from the mobile station, second characteristic information indicating the frequency response of a second node in the wireless network.

2. The method of claim 1, further comprising:
calculating, by the first node, an estimated frequency response of a channel between the first and second nodes.

3. The method of claim 2, further comprising:
calculating, by the first node, a compensated frequency response of the channel between the first and second nodes based on the second characteristic information indicating the frequency response of the second node.

4. The method of claim 1, wherein the first and second characteristic information include transfer functions for the first and second nodes, respectively.

5. The method of claim 1, wherein the first and second characteristic information include vendor and model numbers for the first and second nodes, respectively.

6. The method of claim 1, wherein the frequency responses of the first and second nodes are a combination of the individual frequency responses for each filter in the signal chain in each respective node.

7. The method of claim 3, further comprising:
calculating a round trip time (RTT) for the first node based on the compensated frequency response of the channel.

8. The method of claim 3, further comprising:
calculating a received signal strength indicator (RSSI) for the first node based on the compensated frequency response of the channel.

9. The method of claim 3, further comprising:
detecting cyclic shift diversity (CSD) based on the compensated frequency response of the channel.

10. The method of claim 1, wherein the second characteristic information is contained within assistance data transmitted to the first node.

11. The method of claim 1, wherein the first node transmits the first characteristic information and receives the second characteristic information upon joining the wireless network.

12. A non-transient machine-readable medium comprising instructions, which, when executed by a machine, cause the machine to perform operations, the instructions comprising:
transmit, by a first node, the frequency response of the first node to each node in the wireless network; and
receive, by the first node, the frequency response of each node in the wireless network.

13. The non-transient machine-readable medium of claim 12, wherein the instructions further comprise:
calculating, by the first node, an estimated frequency response of a channel between the first and second nodes.

14. The non-transient machine-readable medium of claim 13, wherein the instructions further comprise:
calculating, by the first node, a compensated frequency response of the channel between the first and second nodes based on the second characteristic information indicating the frequency response of the second node.

15. The non-transient machine-readable medium of claim 12, wherein the first and second characteristic information include transfer functions for the first and second nodes, respectively.

16. The non-transient machine-readable medium of claim 12, wherein the first and second characteristic information include vendor and model numbers for the first and second nodes, respectively.

17. The non-transient machine-readable medium of claim 12, wherein the frequency responses of the first and second nodes are a combination of the individual frequency responses for each filter in the signal chain in each respective node.

18. The non-transient machine-readable medium of claim 14, wherein the instructions further comprise:
calculating a round trip time (RTT) for the first node based on the compensated frequency response of the channel.

19. The non-transient machine-readable medium of claim 14, wherein the instructions further comprise:
calculating a received signal strength indicator (RSSI) for the first node based on the compensated frequency response of the channel.

20. The non-transient machine-readable medium of claim 14, wherein the instructions further comprise:
detecting cyclic shift diversity (CSD) based on the compensated frequency response of the channel.

21. The non-transient machine-readable medium of claim 12, wherein the second characteristic information is contained within assistance data transmitted to the first node.

22. The non-transient machine-readable medium of claim 12, wherein the first node transmits the first characteristic information and receives the second characteristic information upon joining the wireless network.

23. A mobile station, comprising:
a transceiver for receiving characteristic information from a new node joining a network, wherein the characteristic information indicates the frequency response of the new node, and transmitting the frequency response to each node in the network; and
a data store for storing the received frequency response.

24. The mobile station of claim 23, wherein the characteristic information includes a transfer function defining the frequency response for the new node.

25. The mobile station of claim 23, wherein the characteristic information includes a vendor and model number for the new node.

26. The mobile station of claim 25, further comprising:
a lookup table for retrieving the frequency response for the new node based on the vendor and model number.

27. The mobile station of claim 23, wherein the frequency response of the new node is a combination of the individual frequency responses for each component in the signal chain in the new node.

28. The mobile station of claim 23, wherein the characteristic information transmitted to each node in the network is contained within assistance data.

29. A system for performing data communications, comprising:
a first node in a network for transmitting first characteristic information indicating the frequency response of the first node; and
a mobile station for receiving the first characteristic information and broadcasting the frequency response of a second node in the network to the first node.

30. The system of claim 29, wherein the first node performs channel estimation on a channel connecting the first and second nodes based on the frequency response of the second node received from the mobile station.

31. The system of claim 30, wherein the first node calculates a compensated frequency response of the channel between the first and second nodes based on the second characteristic information indicating the frequency response of the second node.

32. The system of claim 29, wherein the first and second characteristic information include transfer functions for the first and second nodes, respectively.

33. The system of claim 29, wherein the first and second characteristic information include vendor and model numbers for the first and second nodes, respectively.

34. The system of claim 29, wherein the frequency responses of the first and second nodes are a combination of the individual frequency responses for each filter in the signal chain in each respective node.

35. The system of claim 31, wherein the first node calculates a round trip time (RTT) based on the compensated frequency response of the channel.

36. The system of claim 31, wherein the first node calculates a received signal strength indicator (RSSI) based on the compensated frequency response of the channel.

37. The system of claim 31, wherein the first node detects cyclic shift diversity (CSD) based on the compensated frequency response of the channel.

38. The system of claim 29, wherein the second characteristic information is contained within assistance data transmitted to the first node.

39. The system of claim 29, wherein the first node transmits the first characteristic information and receives the second characteristic information upon joining the wireless network.

40. A mobile node, comprising:
one or more filters for processing wireless signals; and
a transceiver for (1) transmitting first characteristic information indicating the frequency response of the one more filters to a mobile station in a network and (2) receiving second characteristic information indicating the frequency response of a remote device in the network.

41. The mobile node of claim 40, further comprising:
a hardware processor for calculating an estimated frequency response of a channel between the mobile node and the remote device.

42. The mobile node of claim 41, wherein the hardware processor calculates a compensated frequency response of the channel between the mobile node and the remote device based on the second characteristic information indicating the frequency response of the remote device.

43. The mobile node of claim 40, wherein the first and second characteristic information include transfer functions for the mobile node and the remote device, respectively.

44. The mobile node of claim 40, wherein the first and second characteristic information include vendor and model numbers for the mobile node and the remote device, respectively.

45. The mobile node of claim 40, wherein the frequency response of the mobile node is a combination of the individual frequency responses for each filter of the one or more filters.

46. The mobile node of claim 42, wherein the hardware processor calculates a round trip time (RTT) for the mobile node and the remote device based on the compensated frequency response of the channel.

47. The mobile node of claim 42, wherein the hardware processor detects cyclic shift diversity (CSD) based on the compensated frequency response of the channel.

48. The mobile node of claim 40, wherein the second characteristic information is contained within assistance data transmitted to the mobile node.

49. The mobile node of claim 40, wherein mobile node transmits the first characteristic information and receives the second characteristic information upon joining the network.

50. A mobile station, comprising:
a means for receiving characteristic information from a new node joining a network, wherein the characteristic information indicates the frequency response of the new node, and transmitting the frequency response to each node in the network; and
a means for storing the received frequency response.

51. The mobile station of claim 50, wherein the characteristic information includes a transfer function defining the frequency response for the new node.

52. The mobile station of claim 50, wherein the characteristic information includes a vendor and model number for the new node.

53. The mobile station of claim 52, further comprising:
a means retrieving the frequency response for the new node based on the vendor and model number.

54. The mobile station of claim 50, wherein the frequency response of the new node is a combination of the individual frequency responses for each component in the signal chain in the new node.

55. The mobile station of claim 50, wherein the characteristic information transmitted to each node in the network is contained within assistance data.
